(19) United States
(12) Patent Application Publication
(10) Pub. No.: US 2025/0082009 A1
(43) Pub. Date: Mar. 13, 2025

(54) Levitating Cannabis Concentrate Device

(71) Applicant: Robert Johnson, Lakewood, CO (US)

(72) Inventor: Robert Johnson, Lakewood, CO (US)

(21) Appl. No.: 18/768,085

(22) Filed: Jul. 10, 2024

Related U.S. Application Data
(60) Provisional application No. 63/581,342, filed on Sep. 8, 2023.

(51) Int. Cl. A24F 9/00; B25G 1/10

(52) U.S. Cl. CPC A24F 9/00; B25G 1/102

(57) ABSTRACT

A cannabis concentrate device is disclosed comprising a body component with a metal scoop at a distal end and a stopper component at the proximal end. The metal scoop is made from heat-resistant material that can withstand cleaning chemicals. The stopper component prevents the metal scoop or tip of the scoop from touching a surface by keeping the tip up. The body component also comprises a stainless steel casing with magnets and a textured grip. Furthermore, the body component rests within a stainless steel base component that is magnetic, such that the body component and metal scoop levitates above the base component. The base component may also comprise a back-lit, frosted LED panel and plexiglass end for retaining the body component on the base component.

### CROSS-REFERENCE TO RELATED APPLICATION

The present application claims priority to, and the benefit of, U.S. Provisional Application No. 63/581,342, which was filed on Sep. 8, 2023, and is incorporated herein by reference in its entirety.

### FIELD OF THE INVENTION

The present invention relates generally to the field of cannabis concentrate devices. More specifically, the present invention relates to a tool that can be used to consume marijuana concentrate. Accordingly, the present disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in cannabis concentrate devices. Generally, people consume cannabis in various forms, including cannabis concentrates. However, cannabis concentrates are often sticky. As a result, tools used to consume cannabis concentrates can fall onto surfaces during use and pick up debris that is hard to remove due to the residual concentrate on the surface of the tool.

Furthermore, tools used to consume cannabis concentrates are generally cylindrical, which causes the tools to roll off a surface when set down. Accordingly, most prior art devices for cannabis concentrates do not provide any arrangement to position the dab stick in an elevated position while also preventing the dab stick from rolling around when not in use and thus preventing the tool from getting contaminated and dirty.

Accordingly, there is a demand for an improved cannabis concentrate device that prevents the concentrate tool from falling and getting contaminated. More particularly, there is a demand for a cannabis concentrate device that prevents the device from picking up residual debris which can be hard to remove.

Therefore, there exists a long felt need in the art for a cannabis concentrate device that provides users with a means for consuming marijuana concentrate. There is also a long felt need in the art for a cannabis concentrate device that is not susceptible to falling onto nearby surfaces during use or storage. Further, there is a long felt need in the art for a cannabis concentrate device that prevents the device from picking up residual debris. Moreover, there is a long felt need in the art for a device that comprises a metal scoop made from a heat-resistant material which can withstand cleaning chemicals. Further, there is a long felt need in the art for a cannabis concentrate device that comprises a stopper to prevent the tip of the scoop from touching a surface. Finally, there is a long felt need in the art for a cannabis concentrate device that magnetically levitates above a base.

The subject matter disclosed and claimed herein, in one embodiment thereof, comprises a cannabis concentrate device. The device comprises a body component with a metal scoop at a distal end and a stopper component at the proximal end. The metal scoop is made from heat-resistant material that can withstand cleaning chemicals. The stopper component prevents the metal scoop or tip of the scoop from touching a surface by keeping the tip up. The body component also comprises a stainless steel casing with magnets and a textured grip. Furthermore, the body component rests within a stainless steel base component that is magnetic, such that the body component and metal scoop levitates above the base component. The base component may also comprise a back-lit, frosted LED panel and plexiglass end for retaining the body component on the base component.

In this manner, the cannabis concentrate device of the present invention accomplishes all of the forgoing objectives and provides users with a device that provides a tool for consuming marijuana concentrate. The device is a levitating cannabis concentrate tool that is not susceptible to falling onto nearby surfaces during use or storage. The device can be manufactured of a stainless steel material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cannabis concentrate device. The device comprises a body component with a scoop component at a distal end and a stopper component at the proximal end. The stopper component prevents the scoop component or tip of the scoop from touching a surface by keeping the tip up. The body component also comprises a stainless steel casing with magnets and a textured grip. Furthermore, the body component rests within a stainless steel base component that is magnetic, such that the body component levitates above the base component.

Generally, several types of cannabis concentrate varieties are available in different forms such as oil, shatter, or wax forms. Those skilled in the art will recognize that cannabis concentrate is obtained through an extraction process. In one exemplary method, cannabis concentrate is made by placing cannabis into a long tube or pipe then adding butane, otherwise known as lighter fluid. The butane extracts THC into a hardened, very potent glob (or dab) that looks like ear wax. After the cannabis concentrate is cool, a dab is packed into a water pipe, vaporizer, or bong and smoked. Different types of cannabis concentrate include, without limitation, kief, cannabis wax, water hash, CO2 oil, butane hash oil, rosin, and shatter. The type of cannabis can be medical grade cannabis, or cannabis smoked for recreational purposes.

Unfortunately, when attempting to obtain a portion of the cannabis concentrate with a stick or any such object, it is often necessary to heat the concentrate at the same time. This is because the concentrate must receive optimal heat for smoking purposes. However, both accessing the concentrate, heating the medium, and applying the concentrate on the heated medium is a busty, cumbersome process that may require the cannabis concentrate to be set down on a flat surface. This may cause the cannabis concentrate to smear, and also cause a portion of the concentrate to be lost or contaminated.

In one embodiment, the cannabis concentrate device comprises a body component which is typically cylindrical in shape but can be any suitable shape and size as is known in the art. Further, the body component comprises a distal end and an opposing proximal end. At the distal end, the body component comprises a scoop component or dabber end. At the opposing proximal end, the body component comprises a stopper component. The scoop component is shaped like a shallow spoon to allow a user to scoop up a portion of cannabis concentrate or other suitable substance and retain it on the scoop component for use. Generally, the scoop component is manufactured of a metal material or other suitable heat-resistant material that can withstand cleaning chemicals and degreasers, such as isopropyl alcohol, 409 cleaner, and acetone, etc. Further, the scoop component can withstand high temperatures and is easy to clean, after use.

In another embodiment, the stopper component is utilized to prevent the scoop component or tip of the scoop component from touching a surface by keeping the tip up. Further, the body component can be positioned to rest on the stopper component, thus preventing the tip from touching the table or other surface. When in place on the base component, the stopper component abuts the plexiglass end to help retain the body component in place on the base component. Generally, the body component is manufactured of a stainless steel material or at least a casing of the body component is manufactured of a stainless steel material. Further, the body component comprises a plurality of powerful ring magnets that provide lift when the body component is positioned on the base component. Specifically, the ring magnets of the body component and the magnets of the base component allow the body component to levitate on the base component when not in use. Thus, by inserting the body component on the base component, it is elevated above the ground surface and prevented from rolling off the table or other surface.

In one embodiment, the proximal end is the handle end and is adapted to access concentrate from a source. The handle end is for gripping and manipulating the scoop component. Specifically, the body component comprises a textured grip or other suitable gripping area that allows a user to easily hold and retain the device during use.

In one embodiment, the cannabis concentrate device comprises a base component configured to retain the body component of the cannabis concentrate device. The body component is used for applying a concentrate for use, while also providing the optional functionality of storing the concentrate prior to application to the user. The concentrate may include a cannabis concentrate. Though other suitable concentrates may also be used, as is known in the art.

In one embodiment, the base component can be any suitable shape and size as is known in the art. Further, the base component comprises opposing first and second ends, opposing side components, a top component and a bottom component. The bottom component is generally flat to allow the base component to rest on a table, counter or other ground surface. The top component comprises a trough area, for retaining the body component.

Further, the trough area can be any suitable shape and size as is known in the art and is configured to securely retain and elevate a dabber end or scoop component used for applying the concentrate for use. The scoop component is sized and dimensioned to facilitate holding the concentrate in an elevated, stable position and applying the concentrate for use and consumption of the concentrate.

In one embodiment, the base component, including the trough area which is configured to hold the body component of the cannabis concentrate device, is manufactured of stainless steel or any other suitable metal material and comprises a plurality of magnets which allow the body component to levitate over the trough area. Further, the base component also comprises at least one plexiglass end on either of the opposing first and second ends or both ends. The plexiglass end allows the stopper component to abut the end and retains the body component in place on the base component. Furthermore, in one embodiment, the base component comprises a back-lit frosted LED panel on the opposing side components for aesthetic purposes and to make the device easy to see in the dark or in low light situations.

In yet another embodiment, the cannabis concentrate device comprises a plurality of indicia.

In yet another embodiment, a method of preventing cannabis concentrate from falling and picking up residual debris is disclosed. The method includes the steps of providing a cannabis concentrate device comprising a body component with a metal scoop at a distal end and a stopper component at a proximal end. The method also comprises resting the device on the stopper component when not in use, to prevent the metal scoop from touching a surface. Further, the method comprises positioning the body component within the magnetic base component, such that the body component levitates on the base component. Finally, the method comprises disinfecting the metal scoop with cleaning chemicals and/or high heat.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-C illustrate a perspective view of one embodiment of the cannabis concentrate device of the present invention in accordance with the disclosed architecture;

FIG. 2 illustrates a perspective view of one embodiment of the cannabis concentrate device of the present invention showing the plexiglass end in accordance with the disclosed architecture;

FIG. 3 illustrates a perspective view of one embodiment of the cannabis concentrate device of the present invention showing the metal scoop in accordance with the disclosed architecture;

FIG. 4 illustrates a perspective view of one embodiment of the cannabis concentrate device of the present invention showing the body component resting on the stopper component in accordance with the disclosed architecture;

FIG. 5 illustrates a perspective view of one embodiment of the cannabis concentrate device of the present invention nested within the base component in accordance with the disclosed architecture;

FIG. 6 illustrates a perspective view of one embodiment of the cannabis concentrate device of the present invention in use in accordance with the disclosed architecture;

FIG. 7 illustrates a perspective view of one embodiment of the cannabis concentrate device of the present invention showing the stopper end abutted against the plexiglass end in accordance with the disclosed architecture;

FIGS. 8A-C illustrates a perspective view of one embodiment of the cannabis concentrate device of the present invention showing various components of the device in accordance with the disclosed architecture; and

FIG. 9 illustrates a flowchart showing the method of preventing cannabis concentrate from falling and picking up residual debris in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cannabis concentrate device that provides users with a means for consuming marijuana concentrate. There is also a long felt need in the art for a cannabis concentrate device that is not susceptible to falling onto nearby surfaces during use or storage. Further, there is a long felt need in the art for a cannabis concentrate device that prevents the device from picking up residual debris. Moreover, there is a long felt need in the art for a device that comprises a metal scoop made from a heat-resistant material which can withstand cleaning chemicals. Further, there is a long felt need in the art for a cannabis concentrate device that comprises a stopper to prevent the tip of the scoop from touching a surface. Finally, there is a long felt need in the art for a cannabis concentrate device that magnetically levitates above a base.

The present invention, in one exemplary embodiment, is a novel cannabis concentrate device. The device comprises a body component with a metal scoop at a distal end and a stopper component at the proximal end. The metal scoop is made from heat-resistant material that can withstand cleaning chemicals. The stopper component prevents the metal scoop or tip of the scoop from touching a surface by keeping the tip up. The body component also comprises a stainless steel casing with magnets and a textured grip. Furthermore, the body component rests within a stainless steel base component that is magnetic, such that the body component and metal scoop levitates above the base component. The base component may also comprise a back-lit, frosted LED panel and plexiglass end for retaining the body component on the base component.

The present invention also includes a novel method of preventing cannabis concentrate from falling and picking up residual debris. The method includes the steps of providing a cannabis concentrate device comprising a body component with a metal scoop at a distal end and a stopper component at a proximal end. The method also comprises resting the device on the stopper component when not in use, to prevent the metal scoop from touching a surface. Further, the method comprises positioning the body component within the magnetic base component, such that the body component levitates on the base component. Finally, the method comprises disinfecting the metal scoop with cleaning chemicals and/or high heat.

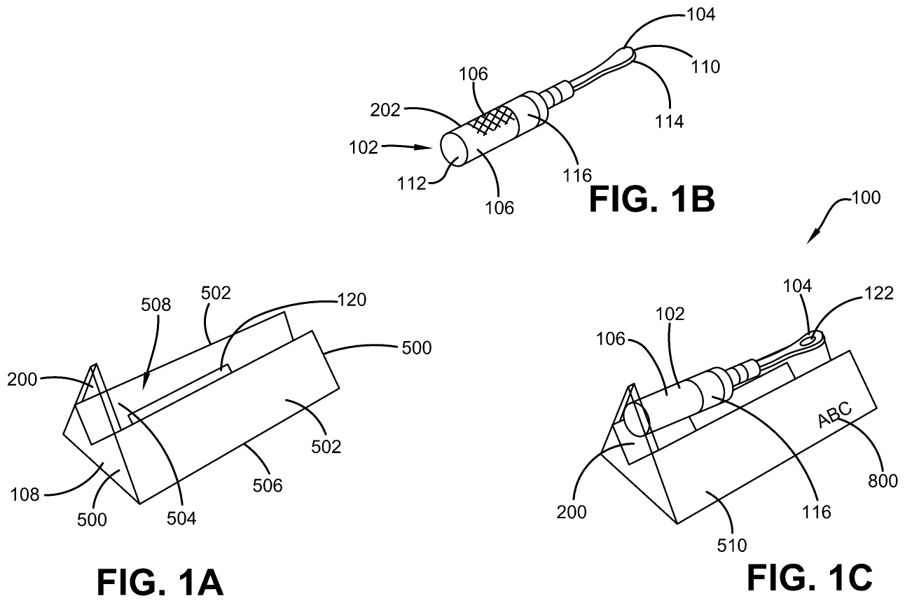

Referring initially to the drawings, FIGS. 1A-C illustrate a perspective view of one embodiment of the cannabis concentrate device 100 of the present invention. In the present embodiment, the cannabis concentrate device 100 is an improved cannabis concentrate device 100 that provides a user with a tool that can be used to consume marijuana concentrate. Specifically, the cannabis concentrate device 100 comprises a body component 102 with a scoop component 104 positioned at a distal end 110 and a stopper component 106 positioned at a proximal end 112. The stopper component 106 prevents the scoop component 104 or tip 114 of the scoop 104 from touching a surface by keeping the tip 114 up. The body component 102 also comprises a plurality of magnets 116 and a textured grip 118. Furthermore, the body component 102 rests within a base component 108 that is magnetic 120, such that the body component 102 levitates above the base component 108.

Generally, several types of cannabis concentrate 122 varieties are available in different forms such as oil, shatter, or wax forms. Those skilled in the art will recognize that cannabis concentrate 122 is obtained through an extraction process. In one exemplary method, cannabis concentrate 122 is made by placing cannabis into a long tube or pipe then adding butane, otherwise known as lighter fluid. The butane extracts THC into a hardened, very potent glob (or dab) that looks like ear wax. After the cannabis concentrate 122 is cool, a dab is packed into a water pipe, vaporizer, or bong and smoked. Different types of cannabis concentrate 122 include, without limitation, kief, cannabis wax, water hash, CO2 oil, butane hash oil, rosin, and shatter. The type of cannabis 122 can be medical grade cannabis, or cannabis smoked for recreational purposes.

Unfortunately, when attempting to obtain a portion of the cannabis concentrate 122 with a stick or any such object, it is often necessary to heat the concentrate 122 at the same time. This is because the concentrate 122 must receive optimal heat for smoking purposes. However, both accessing the concentrate 122, heating the medium, and applying the concentrate 122 on the heated medium is a busty, cumbersome process that may require the cannabis concentrate 122 to be set down on a flat surface. This may cause the cannabis concentrate 122 to smear, and also cause a portion of the concentrate 122 to be lost or contaminated.

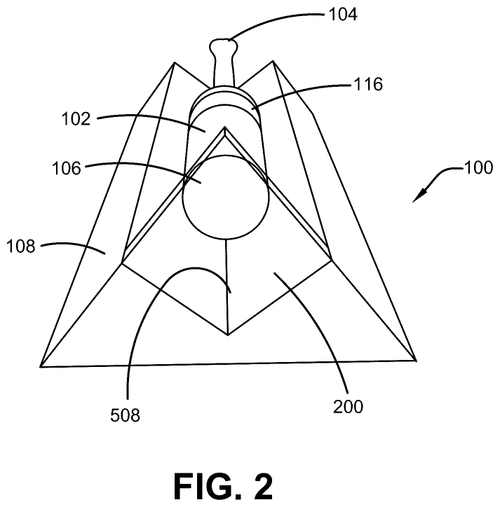

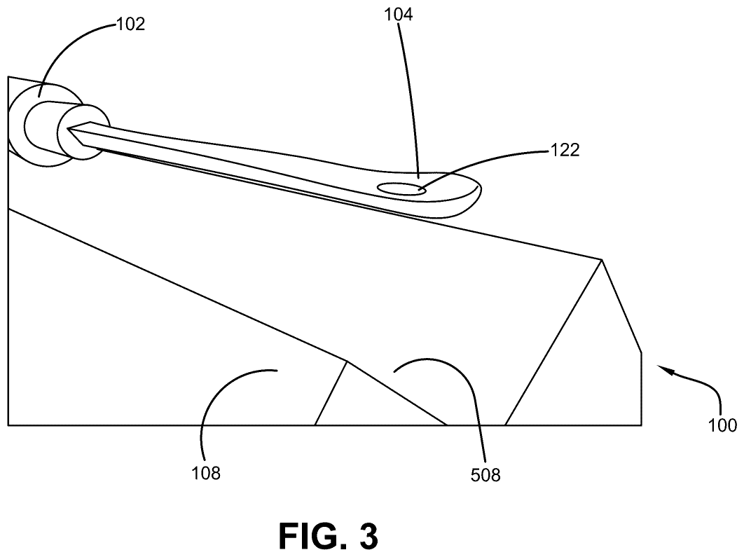

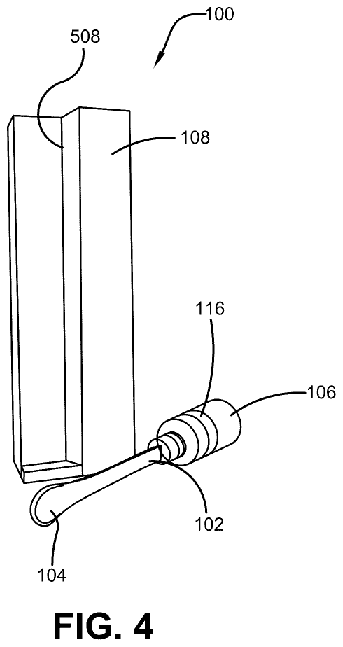

As shown in FIGS. 2-4, the cannabis concentrate device 100 comprises a body component 102 which is typically cylindrical in shape but can be any suitable shape and size as is known in the art. Further, the body component 102 comprises a distal end 110 and an opposing proximal end 112. At the distal end 110, the body component 102 comprises a scoop component 104 or dabber end. At the opposing proximal end 112, the body component 102 comprises a stopper component 106. The scoop component 104 is shaped like a shallow spoon to allow a user to scoop up a portion of cannabis concentrate 122 or other suitable substance and retain it on the scoop component 104 for use. Generally, the scoop component 104 is manufactured of a metal material or other suitable heat-resistant material that can withstand cleaning chemicals and degreasers, such as isopropyl alcohol, 409 cleaner, and acetone, etc. The metal material can be aluminum, bronze, brass, copper, stainless steel, or mixtures thereof, etc., or any other suitable materials as is known in the art. Furthermore, the scoop component 104 can withstand high temperatures and is easy to clean after use due to the metal materials.

Furthermore, the stopper component 106 is utilized to prevent the scoop component 104 or tip 114 of the scoop component 104 from touching a surface by keeping the tip 114 up. Specifically, the body component 102 can be positioned on its proximal end 112, to rest on the stopper component 106, thus preventing the tip 114 from touching the table or other surface. Further, when in place on the base component 108, the stopper component 106 can abut a plexiglass end 200 on the base component 108, to help retain the body component 102 in place on the base component 108 and prevent the body component 102 from rolling off the base component 108, and/or falling to the floor.

Generally, the body component 102 is manufactured of a stainless steel material or at least a casing of the body component 102 is manufactured of a stainless steel material, aluminum, bronze, brass, copper, stainless steel, or mixtures thereof, etc., or any other suitable materials as is known in the art.

Additionally, the body component 102 comprises a plurality of powerful ring magnets 116 that provide lift when the body component 102 is positioned on the base component 108. The magnets 116 can be any suitable magnets as is known in the art. Specifically, the ring magnets 116 of the body component 102 and the magnets 120 of the base component 108 allow the body component 102 to levitate on the base component 108 when not in use. Thus, by inserting the body component 102 on the base component 108, it is elevated above the base component and the ground surface and prevented from rolling off the table or other surface.

Further, the proximal end 112 of the body component 102 is the handle end 202 and is adapted to access the cannabis concentrate 122 from a source. The handle end 202 is for gripping and manipulating the scoop component 104 during use. Specifically, the body component 102 comprises a textured grip 118 or other suitable gripping area that allows a user to easily hold and retain the device 100 during use, without worry of it slipping from their hands.

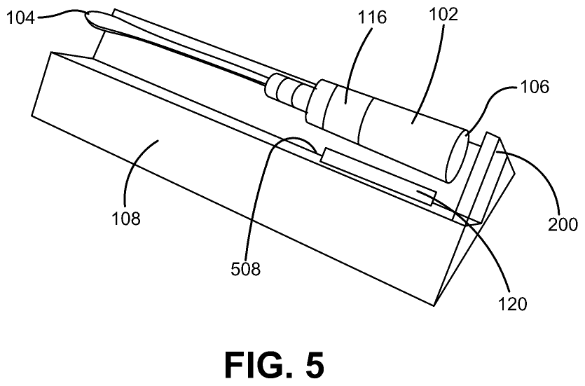

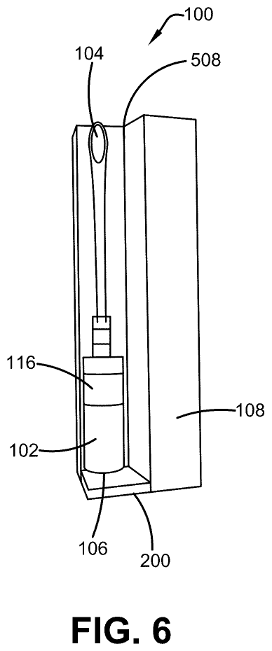

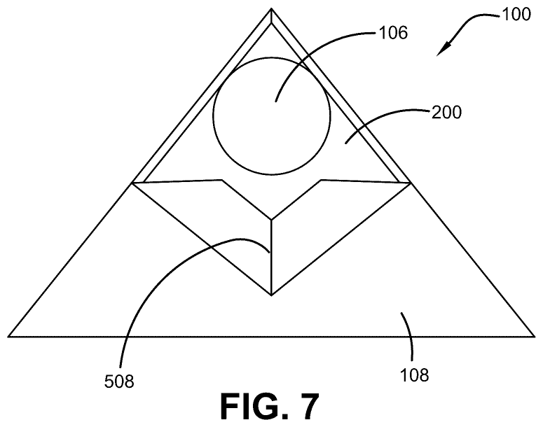

As shown in FIGS. 5-7, the cannabis concentrate device 100 comprises a base component 108 configured to retain the body component 102 of the cannabis concentrate device 100. The body component 102 is used for applying a concentrate 122 for use, while also providing the optional functionality of storing the concentrate 122 prior to application to the user. The concentrate 122 may include a cannabis concentrate 122. Though other suitable concentrates may also be used, as is known in the art.

Generally, the base component 108 can be any suitable shape and size as is known in the art. Further, the base component 108 comprises opposing first and second ends 500, opposing side components 502, a top component 504 and a bottom component 506. The bottom component 506 is generally flat to allow the base component 108 to rest on a table, counter or other ground surface. The top component 504 comprises a trough area 508, for retaining the body component 102.

Further, the trough area 508 can be any suitable shape and size as is known in the art and is configured to securely retain and elevate a body component 102 with a dabber end or scoop component 104 at the distal end 110, which is used for applying the concentrate 122 for use. The scoop component 104 is sized and dimensioned to facilitate holding the cannabis concentrate 122 in an elevated, stable position and applying the concentrate 122 for use and consumption of the concentrate 122.

Additionally, the base component 108, including the trough area 508 which is configured to hold the body component 102 of the cannabis concentrate device 100, is manufactured of stainless steel, aluminum, bronze, brass, copper, or mixtures thereof, etc., or any other suitable metal materials as is known in the art. Further, the base component 108 comprises a plurality of magnets 120 which allow the body component 102 to levitate over the trough area 508. In one embodiment, the base component 108 also comprises at least one plexiglass end 200 on either of the opposing first and second ends 500 or both ends 500, depending on the needs and/or wants of a user. The plexiglass end 200 allows the stopper component 106 to abut the end 500 and retains the body component 102 in place on the base component 108. Furthermore, in one embodiment, the base component 108 comprises a back-lit frosted LED panel 510 on the opposing side components 502 for aesthetic purposes and to make the device 100 easy to see in the dark or in low light situations. Further, any other aesthetic components can be added as well, depending on the needs and/or wants of a user.

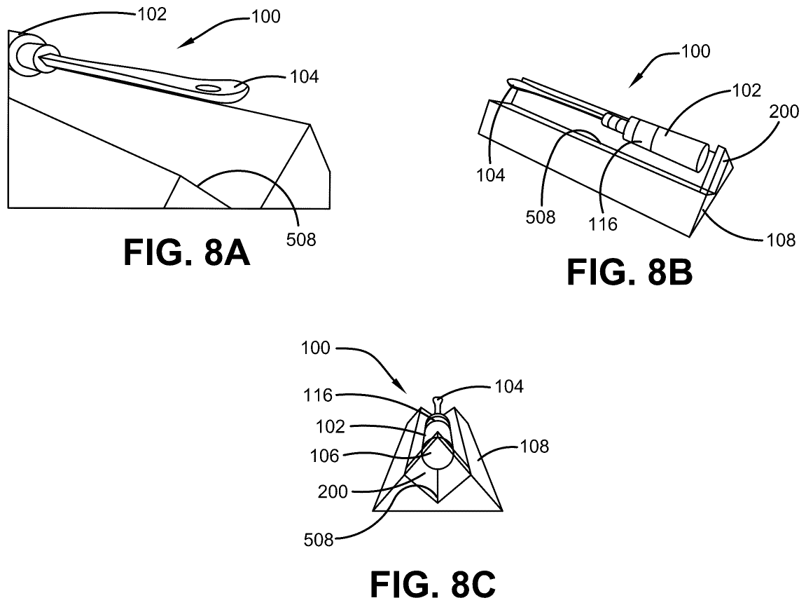

As shown in FIGS. 8A-C, the cannabis concentrate device 100 comprises a plurality of indicia 800. The body component 102 and/or base component 104 of the device 100 may include advertising, a trademark, or other letters, designs, or characters, printed, painted, stamped, or integrated into the body component 102 and/or base component 104, or any other indicia 800 as is known in the art. Specifically, any suitable indicia 800 as is known in the art can be included, such as but not limited to, patterns, logos, emblems, images, symbols, designs, letters, words, characters, animals, advertisements, brands, etc., that may or may not be cannabis, concentrate, or brand related.

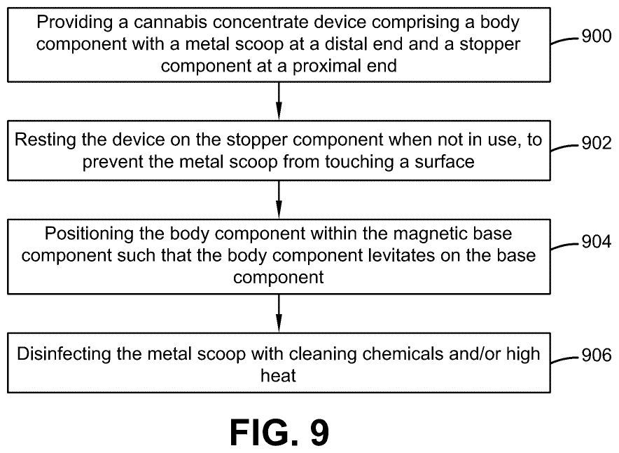

FIG. 9 illustrates a flowchart of the method of preventing cannabis concentrate from falling and picking up residual debris. The method includes the steps of at 900, providing a cannabis concentrate device comprising a body component with a metal scoop at a distal end and a stopper component at a proximal end. The method also comprises at 902, resting the device on the stopper component when not in use, to prevent the metal scoop from touching a surface. Further, the method comprises at 904, positioning the body component within the magnetic base component, such that the body component levitates on the base component. Finally, the method comprises at 906, disinfecting the metal scoop with cleaning chemicals and/or high heat.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cannabis concentrate device”, “cannabis device”, “concentrate device”, and “device” are interchangeable and refer to the cannabis concentrate device 100 of the present invention.

Notwithstanding the forgoing, the cannabis concentrate device 100 of the present invention can be of any suitable size and configuration as is known in the art without affecting the overall concept of the invention, provided that it accomplishes the above stated objectives. One of ordinary skill in the art will appreciate that the cannabis concentrate device 100 as shown in FIGS. 1-9 is for illustrative purposes only, and that many other sizes and shapes of the cannabis concentrate device 100 are well within the scope of the present disclosure. Although the dimensions of the cannabis concentrate device 100 are important design parameters for user convenience, the cannabis concentrate device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cannabis concentrate device that provides a user with a tool that is used to consume marijuana concentrate, the cannabis concentrate device comprising:
a body component; and
a base component; and
wherein the body component comprises a scoop component for scooping an amount of a cannabis concentrate for use;
wherein the body component comprises a stopper component for preventing the scoop component from touching a surface; and
further wherein the body component rests on the base component when not in use.

2. The cannabis concentrate device of claim 1, wherein the body component is cylindrical in shape.

3. The cannabis concentrate device of claim 2, wherein the body component comprises a distal end and an opposing proximal end.

4. The cannabis concentrate device of claim 3, wherein the distal end comprises the scoop component.

5. The cannabis concentrate device of claim 4, wherein the proximal end comprises the stopper component.

6. The cannabis concentrate device of claim 5, wherein the scoop component is shaped like a shallow spoon to allow a user to scoop up a portion of the cannabis concentrate.

7. The cannabis concentrate device of claim 6, wherein the scoop component is manufactured of a heat-resistant material that can withstand cleaning chemicals and degreasers, such as isopropyl alcohol, 409 cleaner, and acetone.

8. The cannabis concentrate device of claim 7, wherein the stopper component is utilized to prevent the scoop component from touching a surface by keeping the scoop component up off the surface.

9. The cannabis concentrate device of claim 8, wherein the body component is positioned on its proximal end, to rest on the stopper component, thus preventing the scoop component from touching the surface.

10. The cannabis concentrate device of claim 9, wherein the body component comprises a plurality of powerful ring magnets that provide lift when the body component is positioned on the base component.

11. The cannabis concentrate device of claim 10, wherein the proximal end of the body component is the handle end, which comprises a textured grip that allows a user to easily hold and retain the body component during use.

12. The cannabis concentrate device of claim 11, wherein the base component comprises opposing first and second ends, opposing side components, a top component and a bottom component.

13. The cannabis concentrate device of claim 12, wherein the bottom component is generally flat to allow the base component to rest on a surface, and the top component comprises a trough area configured for retaining the body component that comprises a plurality of magnets which allow the body component to levitate over the trough area.

14. A cannabis concentrate device that provides a user with a tool that is used to consume marijuana concentrate, the cannabis concentrate device comprising:
a body component with a distal end and a proximal end; and
a base component; and
wherein the distal end comprises a scoop component for scooping an amount of a cannabis concentrate for use;
wherein the proximal end comprises a stopper component for preventing the scoop component from touching a surface;
wherein the body component is positioned on its proximal end, to rest on the stopper component, thus preventing the scoop component from touching the surface;
wherein the body component comprises a plurality of powerful ring magnets that provide lift when the body component is positioned on the base component;
wherein the proximal end of the body component is the handle end, which comprises a textured grip that allows a user to easily hold and retain the body component during use;
wherein the base component comprises a trough area configured for retaining the body component; and
further wherein the base component comprises a plurality of magnets located near the trough area, which allow the body component to levitate over the trough area, when so positioned.

15. The cannabis concentrate device of claim 14, wherein the base component comprises a plexiglass end for retaining the body component in position.

16. The cannabis concentrate device of claim 14, wherein the base component comprises a back-lit frosted LED panel for aesthetic purposes.

17. The cannabis concentrate device of claim 14 further comprising a plurality of indicia.

18. The cannabis concentrate device of claim 14, wherein the scoop component is shaped like a shallow spoon to allow a user to scoop up a portion of the cannabis concentrate.

19. The cannabis concentrate device of claim 14, wherein the scoop component is manufactured of a heat-resistant material that can withstand cleaning chemicals and degreasers, such as isopropyl alcohol, 409 cleaner, and acetone.

20. A method of preventing cannabis concentrate from falling and picking up residual debris, the method comprising the following steps:
providing a cannabis concentrate device comprising a body component with a metal scoop at a distal end and a stopper component at a proximal end;
resting the device on the stopper component when not in use, to prevent the metal scoop from touching a surface;
positioning the body component within the magnetic base component, such that the body component levitates on the base component; and
disinfecting the metal scoop with cleaning chemicals and/or high heat.
